(19) United States
(12) Patent Application Publication
(10) Pub. No.: US 2021/0139035 A1
(43) Pub. Date: May 13, 2021

(54) ECO-FRIENDLY VEHICLE AND A METHOD OF CONTROLLING MOTOR TORQUE OF AN ECO-FRIENDLY VEHICLE

(71) Applicants: HYUNDAI MOTOR COMPANY, Seoul (KR); KIA MOTORS CORPORATION, Seoul (KR)

(72) Inventors: Sora Jang, Gwacheon-si (KR); Gwi Chul Kim, Anyang-si (KR)

(73) Assignees: HYUNDAI MOTOR COMPANY, Seoul (KR); KIA MOTORS CORPORATION, Seoul (KR)

(21) Appl. No.: 16/838,814

(22) Filed: Apr. 2, 2020

(30) Foreign Application Priority Data
Nov. 12, 2019 (KR) 10-2019-0144201

(51) Int. Cl. B60W 30/18; B60W 10/08; B60W 40/068

(52) U.S. Cl. CPC B60W 30/18172; B60W 10/08; B60W 50/14; B60W 2710/083; B60W 40/068

(57) ABSTRACT

An eco-friendly vehicle includes a motor, and a motor torque of the eco-friendly vehicle is controlled by determining road surface characteristics based on wheel behavior characteristics when controlling starting of the eco-friendly vehicle and by controlling the torque of the motor before a significant wheel spin occurs when the vehicle is started based on road characteristic determination results. A method of controlling the motor torque of the eco-friendly vehicle includes determining a wheel behavior characteristic of the vehicle, determining a road surface characteristic of a road on which the vehicle is located based on the wheel behavior characteristic of the vehicle, and controlling the motor torque of the vehicle based on the road surface characteristic.

### CROSS-REFERENCE TO RELATED APPLICATION(S)

This application is based on and claims priority under 35 U.S.C. § 119 to Korean Patent Application No. 10-2019-0144201, filed on Nov. 12, 2019 in the Korean Intellectual Property Office, the disclosure of which is incorporated herein by reference in its entirety.

### TECHNICAL FIELD

The disclosure relates to a vehicle, and more particularly, to a vehicle having a motor as a power source for generating a driving force of a wheel.

### BACKGROUND

In an eco-friendly vehicle having a motor, i.e., an electric motor, as a power source for generating a driving force of a wheel, the motor is more responsive than an engine, i.e., an internal combustion engine. The eco-friendly vehicle can produce high torque, so momentary acceleration capability is excellent. In addition, in the case of an electric vehicle, a tire having a very small frictional force is adopted to increase a distance that can be driven by one time of full charge, in which case the tire's traction (grip) is reduced.

The eco-friendly vehicle equipped with the motor generates fast and large wheel spins of the driving wheels on a low friction road surface, which may result in poor starting stability of the vehicle. Currently, a control is applied to reduce motor torque when wheel spin of a driving wheel occurs more than a predetermined magnitude. However, since the wheel spin occurs quickly and largely due to characteristics of the eco-friendly vehicle having the motor, there is a problem that the wheel spin is not sufficiently reduced even when the motor torque is controlled.

### SUMMARY

Therefore, an aspect of the disclosure is to determine road surface characteristics based on wheel behavior characteristics when controlling a starting of an eco-friendly vehicle equipped with a motor. Another aspect of the disclosure is to control a torque of the motor before significant wheel spin occurs when the vehicle is started based on road characteristic determination results.

Additional aspects of the disclosure are set forth in part in the description which follows and, in part, should be obvious from the description, or may be learned by practice of the disclosure.

In accordance with an aspect of the disclosure, a method of controlling a motor torque of an eco-friendly vehicle includes: determining a wheel behavior characteristic of a vehicle; determining a road surface characteristic of a road on which the vehicle is located based on the wheel behavior characteristic of the vehicle; and controlling a motor torque of the vehicle based on the road surface characteristic.

The determining of the wheel behavior characteristic of the vehicle may include determining the wheel behavior characteristic of the vehicle using a wheel jerk, a wheel speed, and the motor torque of the vehicle.

The determining of the road surface characteristic of the road may include, when a wheel jerk Wⱼₑᵣₖ and a motor torque Tₘₒₜₒᵣ of the vehicle satisfy each preset reference range, and when a wheel acceleration W_{decel} and a wheel acceleration code count value Cnt_{wdecel} satisfy each preset reference range, determining the road surface characteristic as a low friction road surface.

The determining of the road surface characteristic of the road may include, when the wheel jerk Wⱼₑᵣₖ and the motor torque Tₘₒₜₒᵣ of the vehicle do not satisfy each preset reference range, and when the wheel acceleration W_{decel} and the wheel acceleration code count value Cnt_{wdecel} do not satisfy each preset reference range, determining the road surface characteristic as a high friction road surface.

The method may further include calculating the wheel acceleration or the wheel jerk based on the rate of change of a wheel speed of a left driving wheel and a right driving wheel of the vehicle.

The wheel acceleration may be calculated as in Equation 1 below.

$${W}_{decel} = 0.5 * ⌊ \frac{d}{dt} ( {WSPD}_{LH} ) + \frac{d}{dt} ( {WSPD}_{RH} ) ⌋ \qquad 〈 Equation 1 〉$$

In Equation 1, W_{decel} is the wheel acceleration, and WSPD_{LH} and WSPD_{RH} are wheel speeds of left and right drive wheels.

The wheel jerk may be calculated as in Equation 2 below.

$${W}_{jerk} = 0.5 * ⌊ \frac{{d}^{2}}{{dt}^{2}} ( {WSPD}_{LH} ) + \frac{{d}^{2}}{{dt}^{2}} ( {WSPD}_{RH} ) ⌋ \qquad 〈 Equation 2 〉$$

In Equation 2, Wⱼₑᵣₖ is the wheel jerk, and WSPD_{LH} and WSPD_{RH} are wheel speeds of left and right drive wheels.

The controlling of the motor torque of the vehicle may include controlling the motor torque to reduce a wheel spin of the vehicle when the determined road surface characteristic is the low friction road surface.

The method may further include displaying a result of determining the road surface characteristic on a display.

The displaying may include displaying on the display that the current road surface is a low friction road surface when the road surface characteristic determination result is the low friction road surface.

In accordance with another aspect of the disclosure, an eco-friendly vehicle includes a motor configured to generate power for driving a vehicle and a controller. The controller is configured to: determine a wheel behavior characteristic of the vehicle; determine a road surface characteristic of a road on which the vehicle is located based on the wheel behavior characteristic of the vehicle; and control a motor torque of the vehicle based on the road surface characteristic.

The controller may be configured to determine the wheel behavior characteristic of the vehicle using a wheel jerk, a wheel speed, and the motor torque of the vehicle.

When a wheel jerk Wⱼₑᵣₖ and a motor torque Tₘₒₜₒᵣ of the vehicle satisfy each preset reference range, and when a wheel acceleration W_{decel} and a wheel acceleration code count value Cnt_{wdecel} satisfy each preset reference range, the controller may be configured to determine the road surface characteristic as a low friction road surface.

When the wheel jerk Wⱼₑᵣₖ and the motor torque Tₘₒₜₒᵣ of the vehicle do not satisfy each preset reference range, and when the wheel acceleration W_{decel} and the wheel acceleration code count value Cnt_{wdecel} do not satisfy each preset reference range, the controller may be configured to determine the road surface characteristic as a high friction road surface.

The controller may be configured to calculate the wheel acceleration or the wheel jerk based on the rate of change of a wheel speed of a left driving wheel and a right driving wheel of the vehicle.

The controller may be configured to calculate the wheel acceleration as in Equation 1 below.

$${W}_{decel} = 0.5 * ⌊ \frac{d}{dt} ( {WSPD}_{LH} ) + \frac{d}{dt} ( {WSPD}_{RH} ) ⌋ \qquad 〈 Equation 1 〉$$

In Equation 1, W_{decel} is the wheel acceleration, and WSPD_{LH} and WSPD_{RH} are wheel speeds of left and right drive wheels.

The controller may be configured to calculate the wheel jerk as in Equation 2 below.

$${W}_{jerk} = 0.5 * ⌊ \frac{{d}^{2}}{{dt}^{2}} ( {WSPD}_{LH} ) + \frac{{d}^{2}}{{dt}^{2}} ( {WSPD}_{RH} ) ⌋ \qquad 〈 Equation 2 〉$$

In Equation 2, Wⱼₑᵣₖ is the wheel jerk, and WSPD_{LH} and WSPD_{RH} are wheel speeds of left and right drive wheels.

The controller may be configured to control the motor torque to reduce a wheel spin of the vehicle when the determined road surface characteristic is the low friction road surface.

The controller may be configured to display a result of determining the road surface characteristic on a display.

The controller may be configured to display on the display that the current road surface is a low friction road surface when the road surface characteristic determination result is the low friction road surface.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a control system of a vehicle according to embodiments of the disclosure.

FIG. 2 is a view illustrating a method of controlling motor torque of a vehicle according to embodiments of the disclosure.

FIG. 3 is a view illustrating a method of determining whether to use past motor torque control data in a method of controlling motor torque of a vehicle according to embodiments of the disclosure.

FIG. 4 is a view illustrating a wheel behavior characteristic determination and a road surface characteristic determination in a method of controlling motor torque of a vehicle according to embodiments of the disclosure.

FIGS. 5A and 5B are views illustrating a road surface characteristic determination reference in a motor torque control of a vehicle according to embodiments of the disclosure.

FIG. 6 is a view illustrating different aspects of a method of controlling motor torque of a vehicle according to embodiments of the disclosure.

### DETAILED DESCRIPTION

FIG. 1 is a view illustrating a control system of a vehicle according to embodiments of the disclosure.

A controller 102 may be provided to control an overall operation of a vehicle. In particular, the controller 102 of the vehicle may determine a current road surface state to generate a road surface determination result. The controller 102 may control a torque of a motor 150 so that wheel spin does not occur when the vehicle starts (or at least the wheel spin is minimized) according to the generated road surface determination result to secure driving stability of the vehicle. The controller 102 may be any one of a plurality of electronic control units provided in the vehicle.

The controller 102 may internally include a wheel behavior determination logic 104 and a road surface determination logic 106. The road surface state may refer to a friction coefficient of the road surface. The higher the friction coefficient of the road surface, the greater the traction between a wheel and the road surface, so that the wheel spin does not occur or decreases. Conversely, the lower the friction coefficient of the road surface, the lesser the traction between the wheel and the road surface, so that the wheel spin increases.

The wheel behavior determination logic 104 may collect information related to the wheel's behavior and determine the wheel's behavior based on the collected information. The information related to the wheel's behavior may include a wheel speed, a wheel acceleration, and a wheel jerk. The road surface determination logic 106 may determine the state of the road surface based on the wheel behavior determination result of the wheel behavior determination logic 104.

The wheel jerk may refer to a sudden movement in the front and rear direction of the wheel when the vehicle is started (starting). The amount of change in wheel acceleration per unit time (i.e., derivative of wheel acceleration) may be used to estimate a magnitude (degree) of the wheel jerk. Differentiating the wheel speed may obtain the wheel acceleration. Differentiating the wheel acceleration may obtain the wheel jerk's value.

To this end, the controller 102 may determine or obtain the wheel acceleration, the wheel jerk, the wheel spin, a motor torque control value, a vehicle speed, a vehicle deceleration, a road surface state, and the like using various information input from the outside.

The wheel behavior determination logic 104 of the controller 102 may use the various information received from the outside to perform the following operation.

Wheel acceleration calculation and wheel acceleration sign verification:

$${W}_{decel} = 0.5 * ⌊ \frac{d}{dt} ( {WSPD}_{LH} ) + \frac{d}{dt} ( {WSPD}_{RH} ) ⌋ \qquad 〈 Equation 1 〉$$

In Equation 1, W_{decel} is the wheel acceleration, and WSPD_{LH} and WSPD_{RH} are wheel speeds of left and right drive wheels.

Wheel jerk:

$${W}_{jerk} = 0.5 * ⌊ \frac{{d}^{2}}{{dt}^{2}} ( {WSPD}_{LH} ) + \frac{{d}^{2}}{{dt}^{2}} ( {WSPD}_{RH} ) ⌋ \qquad 〈 Equation 2 〉$$

In Equation 2, Wⱼₑᵣₖ is the wheel jerk, and WSPD_{LH} and WSPD_{RH} are wheel speeds of left and right drive wheels.

Wheel spin:

Wₛₚᵢₙ=v_{whl}−v_{vehicle} <Equation 3>

In equation 3, V_{whl} is the wheel speed of non-drive wheels and v_{vehicle} is the vehicle speed.

Vehicle speed and deceleration:

$${v}_{vehicle} = 0.5 * ( {v}_{rl} + {v}_{rh} ) , {v}_{decel} = \frac{d}{dt} ( {v}_{vehicle} ) \qquad 〈 Equation 4 〉$$

In equation 4, v_{vehicle} is the vehicle speed and v_{decel} is the vehicle deceleration.

A control area network (CAN) signal receiver 122 may receive various signals (information) transmitted through a CAN provided in the vehicle and transmit them to the controller 102.

The navigation 124 may provide a current position of the vehicle to the controller 102. The controller 102 may withdraw a past road surface determination result of where the vehicle is currently located from a memory 170 to be described on the basis of information of the current position of the vehicle provided from the navigation 124. The controller 102 may utilize the torque control of the motor 150 according to the road surface state.

A Hill-start Assist Control (HAC) 126 may prevent the vehicle from being pushed back by temporarily operating a brake when the vehicle stops on a slope and then starts. The controller 102 may receive control information for preventing slope rolling by communicating with the HAC 126 through the CAN. The controller 102 may distinguish whether or not the slope of a place where the vehicle is currently located is slow or rapid by the control information provided from the HAC 126.

A temperature detector 132 may be provided to detect an outdoor temperature around the vehicle. Information about the outdoor temperature detected by the temperature detector 132 may be provided to the controller 102. In the above description of the navigation 124, the controller 102 may withdraw the past road surface determination result of where the vehicle is currently located from the memory to utilize the torque control of the motor 150 according to the road surface state. At this time, when the outdoor temperature is 0° C. or higher, the controller 102 may utilize past road surface state information (see 206 in FIG. 2). On the contrary, when the outdoor temperature is less than 0° C., the controller 102 may perform torque control of another aspect without utilizing the past road surface state information (see 218 in FIG. 2). The controller 102 may perform a motor torque control by referring to a temperature of a driving system of the vehicle together with the outdoor temperature.

A wheel speed detector 134 may be provided to detect a rotational speed of the wheel of the vehicle. The wheel speed detected by the wheel speed detector 134 may be provided to the controller 102. The controller 102 may calculate the wheel acceleration and the wheel jerk based on wheel speed information provided from the wheel speed detector 134. The controller 102 obtain wheel behavior characteristics of the vehicle from information of the wheel speed, the wheel acceleration, and the wheel jerk.

A vehicle speed detector 136 may be provided to detect a driving speed of the vehicle. Vehicle speed information detected by the vehicle speed detector 136 may be provided to the controller 102. The controller 102 may calculate the wheel spin Wₛₚᵢₙ from the difference between the wheel speed v_{whl} and the vehicle speed V_{vehicle}.

The motor 150 is a power source for driving the vehicle. The vehicle may be an electric vehicle driven only by the power of the motor 150 or a hybrid vehicle using both the power of the motor 150 and the engine (not shown).

A cluster 160 is a display that displays various driving information of the vehicle. In particular, the cluster 160 of the vehicle may display the road surface determination result. A passenger of the vehicle may recognize the road surface state of a road on which the vehicle is currently driving from the road surface determination result displayed in the cluster 160.

A memory 170 is a storage that stores various information and data generated in the vehicle. In particular, the memory 170 of the vehicle may store the road surface determination result for each position or location. When a new road surface determination result occurs at the same position, the controller 102 may update an existing road surface determination result of the position stored in the memory 170 with the new road surface determination result.

FIG. 2 is a view illustrating a method of controlling motor torque of a vehicle according to embodiments of the disclosure. In a method of controlling the motor torque of the vehicle illustrated in FIG. 2, a road surface characteristic of the place where the vehicle is located is determined through the wheel behavior characteristics of the vehicle. The motor torque of the vehicle is controlled according to the determined road surface characteristic.

First, the controller 102 may receive the various signals (information) transmitted through the CAN of the vehicle through the can signal receiver 122 (202). For example, the controller 102 may obtain the control information of the HAC and torque information of the motor 150 from the CAN signal. The controller 102 may distinguish whether or not the slope of the place where the vehicle is currently located is slow or rapid from the control information provided from the HAC 126. The torque information of the motor 150 may be utilized to control the motor 150 such that a current torque of the motor 150 follows a target torque.

The controller 102 may also determine whether to utilize past motor torque control data stored in the memory 170 (204). When the past road surface determination data at the current position is stored in the memory 170, the controller 102 may determine whether to utilize the past road surface determination data stored in the memory 170 or attempt a new road surface determination.

This is described with reference to FIG. 3. FIG. 3 is a view illustrating a method of determining whether to use past motor torque control data (204) in a method of controlling motor torque of a vehicle according to embodiments of the disclosure.

To this end, the controller 102 may identify whether the data on which the road surface determination has been performed in the past at the current position or location of the vehicle is stored in the memory 170 (302).

When a history of a low friction road surface in the past at the current position of the vehicle has been stored in the memory 170 (YES in 304), the controller 102 may identify that the temperature outside the current vehicle, i.e., the outdoor temperature, is below 0° C. (304). When the outdoor temperature is below 0° C., i.e., when the current position has historically been determined as the low friction road surface (YES in 304) and the current outdoor temperature is below 0° C. (YES in 306), the controller 102 may determine that the road surface at the current position is the low friction road surface and may perform the motor torque control (see low friction road surface control step 2 (see 218 in FIG. 2)) for stable starting of the vehicle on the low friction road surface. Conversely, when there is no the history of low friction roads in the past (NO in 304) or when there is a history of low friction roads in the past, when the current outdoor temperature is above 0° C. (NO in 306), the controller 102 may determine that road surface state information needs to be updated and attempt to determine new road surface characteristics (see 206 and 208 in FIG. 2).

Returning to FIG. 2, when it is determined that a new road surface characteristic determination is necessary (NO in 204), the controller 102 may perform a wheel behavior characteristic determination as a preliminary operation of the road surface characteristic determination (206). According to the road surface state, the wheel behavior characteristics of the vehicle are different. The wheel behavior characteristics may include, for example, the wheel acceleration and the wheel jerk. In other words, since the wheel acceleration and the wheel jerk are different on the low friction road surface and the high friction road surface, the controller 102 may determine the road surface characteristics through the wheel behavior characteristics such as the wheel acceleration and the wheel jerk.

In addition, the controller 102 may determine the characteristic of the road surface on which the current vehicle is located according to the wheel behavior characteristic determination result (208).

The road surface characteristic determination based on the wheel behavior characteristic determination is described with reference to FIGS. 4, 5A, and 5B. FIG. 4 is a view illustrating a wheel behavior characteristic determination (206) and a road surface characteristic determination (208) in a method of controlling motor torque of a vehicle according to embodiments of the disclosure. FIGS. 5A and 5B are views illustrating a road surface characteristic determination reference in a motor torque control of a vehicle according to embodiments of the disclosure.

Various road surface aspects illustrated in FIGS. 4, 5A, and 5B may each be defined as follows.

A dry road surface is a general pavement that is not wet. A wet road surface is a road where the general pavement is wet. In the embodiment of the disclosure, the dry road surface and the wet road surface may be classified as the high friction road surface. On the high friction road surfaces, the traction between the wheels and the road surface is large enough that no special motor torque control is required at the start of the vehicle.

The slope may refer to a road where the road is not flat and is inclined. The detection of the slope or a detection of a gradient may be detected through the operation of the HAC 126 of the vehicle or by an acceleration sensor provided in the vehicle.

A specific road surface may refer to a speed bump, a manhole cover, a gravel field, a Belgian road surface, or the like. The Belgian road surface is a bumpy road made of small bricks, also known as Belgian road. In the embodiment of the disclosure, the specific road surface is also classified into the high friction road surface. In other words, all the road surfaces except the low friction road surface may be classified as the high friction road surface.

A snow road or an icy road may be a road surface where snow or water is frozen on the road surface due to low outdoor temperature. In the embodiment of the disclosure, the snow road or the ice road may be classified as the low friction road surface. In the snow road or the ice road, the traction between the wheel and the road surface is significantly reduced, requiring a special motor torque control when the vehicle starts.

As illustrated in FIG. 4, the controller 102 may obtain data necessary for the wheel behavior characteristic determination to determine the wheel behavior characteristic determination (462). The data necessary for the wheel behavior characteristic determination may include a CAN signal and the position or location information, slope anti-roll control information, the outdoor temperature, the wheel speed, the vehicle speed, the motor torque, the data stored in the memory 170, and the like.

First, the controller 102 may identify whether the wheel jerk Wⱼₑᵣₖ and the motor torque Tₘₒₜₒᵣ satisfy each preset reference range (464). In other words, when the wheel jerk Wⱼₑᵣₖ exceeds a wheel jerk reference value α, and the motor torque Tₘₒₜₒᵣ is less than a motor torque reference value β, the controller 102 may determine that the wheel jerk Wⱼₑᵣₖ and the motor torque Tₘₒₜₒᵣ satisfies each preset reference range (see FIG. 5A).

The wheel jerk reference value a may be determined by detecting the wheel jerk in each road surface aspect through experiments of starting the vehicle on various road surfaces. For example, as illustrated in FIG. 5A, a value ‘α’ may be set for distinguishing the wheel jerk value on the road, including the dry road surface, the wet road surface, and the slope, from the wheel jerk value on the road, including the specific road surface, the snow road, and the icy road. The value a may be set as the wheel jerk reference value α.

The motor torque reference value ‘β’ may be also determined by detecting the torque value of the motor 150 in each road aspect through experiments of starting the vehicle on various road surfaces. For example, as illustrated in FIG. 5A, a value ‘β’ may be set for distinguishing the motor torque on the road, including the dry road surface, the wet road surface, and the slope, from the motor torque on the road, including the specific road surface, the snow road, and the icy road. The value β may be set as the motor torque reference value β.

Therefore, when the wheel jerk Wⱼₑᵣₖ exceeds the wheel jerk reference value a at the current position of the vehicle, it means that the current road surface may be the snow road, the icy road, or the specific road surface. In addition, when the motor torque Tₘₒₜₒᵣ is less than the motor torque reference value β at the current position of the vehicle, it means that the current road surface may be the snow road, the icy road, or the specific road surface. When the wheel jerk Wⱼₑᵣₖ exceeds the wheel jerk reference value a and the motor torque Tₘₒₜₒᵣ is less than the motor torque reference value β at the current position of the vehicle, it means that the current road surface is very likely to be the snow road, the icy road, or the specific road surface.

When the wheel jerk Wⱼₑᵣₖ and the motor torque Tₘₒₜₒᵣ satisfy each preset reference range (YES in 464), the controller 102 may identify whether the wheel acceleration W_{decel} and the wheel acceleration code count value Cnt_{wdecel} satisfy each preset reference range (466). The wheel acceleration code may indicate the direction in which the wheel acceleration changes with a sign (+) (0) (−). The amount of change per unit time of wheel speed, i.e., the wheel acceleration becomes larger when the wheel acceleration is positive, and the wheel acceleration becomes smaller when the wheel acceleration is negative. When the sign is (0), the wheel acceleration is maintained as it is. The wheel acceleration code count value Cnt_{wdecel} may be a value obtained by counting and accumulating the wheel acceleration code at predetermined intervals.

When the wheel acceleration W_{decel} exceeds a wheel acceleration reference value ‘y’ and the wheel acceleration code count value Cnt_{wdecel} is less than a wheel acceleration code count reference value ‘θ’, the controller 102 may determine that the wheel acceleration W_{decel} and the wheel acceleration code count value Cnt_{wdecel} satisfy each preset reference range (see FIG. 5B).

The wheel acceleration reference value γ may be determined by detecting the wheel acceleration on each road surface through experiments of starting the vehicle on various road surfaces. For example, as illustrated in FIG. 5B, a value γ may be set for distinguishing the wheel acceleration on the road, including the specific road surface and the dry road surface, from the wheel acceleration on the road, including the wet road, the specific road surface, the snow road, and the icy road. The value γ may be set as the wheel acceleration reference value γ.

The wheel acceleration code count reference value Cnt_{wdecel} may also be determined by detecting the wheel acceleration code on each road surface through experiments of starting the vehicle on various road surfaces. For example, as illustrated in FIG. 5B, a value θ may be set for distinguishing the wheel acceleration code count value on the road, including the specific road surface, the dry road surface, and the wet road surface, from the wheel acceleration code count value on the road, including the snow road and the icy road. The value θ may be set as the wheel acceleration code count reference value θ.

Therefore, when the wheel acceleration W_{decel} exceeds the wheel acceleration reference value γ, it means that the current road surface may be the wet road surface, the specific road surface, the snow road, or the icy road. In addition, when the wheel acceleration code count reference value Cnt_{wdecel} is less than the wheel acceleration code count reference value θ, it means that the current road surface may be the snow road or the icy road. When the wheel acceleration W_{decel} exceeds the wheel acceleration reference value γ and the wheel acceleration code count reference value Cnt_{wdecel} is less than the wheel acceleration code count reference value θ, it means that the current road surface is very likely to be the snow road, the icy road, or the specific road surface.

In operation 466 of FIG. 4, when the wheel acceleration W_{decel} and the wheel acceleration code count value Cnt_{wdecel} satisfy each preset reference range (YES in 466), the controller 102 may determine the current road surface as the low friction road surface (482). Conversely, when the wheel acceleration W_{decel} and the wheel acceleration code count value Cnt_{wdecel} do not satisfy each preset reference range (NO in 466), the controller 102 may determine the current road surface as the specific road surface (484).

Returning to 464 of FIG. 4, when the wheel jerk Wⱼₑᵣₖ and the motor torque Tₘₒₜₒᵣ do not satisfy each preset reference range (NO in 464), the controller 102 may identify whether the slope anti-rolling operation is performed by communicating with the HAC 126 or may determine whether the current road surface is a slope (468).

When the HAC 126 operates or the road surface is determined to be a slope (YES in 468), the controller 102 may determine that the road surface is a ramp road (uphill). Since the HAC 126 operates on the uphill road, the controller 102 may identify that the current road surface is the ramp road through the operation of the HAC 126. Conversely, when the HAC 126 does not operate or the road surface is determined to not be the ramp road (NO in 468), the controller 102 may determine that the road surface is the high friction road surface (488). In other words, when the current road surface is not the low friction road surface and is not the slope, the controller 102 may determine that the road surface as the high friction road surface.

As illustrated in FIGS. 5A and 5B, the road surface may be classified as the ‘dry road surface’, the ‘wet road surface’, a ‘slope’, the ‘specific road surface’, the ‘snow road’, and the ‘icy road’ according to the wheel jerk Wⱼₑᵣₖ, the motor torque Tₘₒₜₒᵣ, the wheel acceleration W_{decel}, and the wheel acceleration code count value Cnt_{wdecel}.

In FIGS. 5A and 5B, the snow road and the icy road are the low friction road surfaces. The low friction road surface may be defined as the low friction road surface at a level at which the traction force necessary for the vehicle to start stably is not obtained.

The reference for determining the characteristics of the road surface as the low friction road surface may be applied differently depending on the vehicle. In other words, the traction force necessary for the vehicle to start stably varies depending on a load of the vehicle and a state of the tires. Accordingly, it is desirable to determine the reference values (α, β, γ, θ, etc. in FIG. 4) to distinguish or identify the ‘low friction road’ requiring the motor torque control by obtaining and analyzing data through experiments on various kinds of road surfaces.

Returning to FIG. 2, when it is determined that the current road surface is the low friction road surface (YES in 210), the controller 102 may perform a low friction road surface motor torque control step 1 (212). When using the past motor torque control data in operation 204 described above (YES in 204), the controller 102 may perform the low friction road surface motor torque control step 2 (218).

The low friction road surface motor torque control step 1 (see 212 in FIG. 2) and the low friction road surface motor torque control step 2 (see 218 in FIG. 2) are described with reference to FIG. 6 as follows.

FIG. 6 is a view illustrating different aspects of a method of controlling motor torque of a vehicle according to embodiments of the disclosure. FIG. 2 described above illustrates two instances 212 and 218 of motor torque control of the vehicle on the low friction road surface. In other words, when the new road surface characteristic is determined without utilizing the past motor torque control data as it is (NO in 204), the controller 102 may perform the low friction road surface motor torque control step 1(see 212 in FIG. 2).

Conversely, when utilizing the past motor torque control data (YES in 204) to determine the new road surface characteristic, the controller 102 may perform the low friction road surface motor torque control step 2 (see 218 in FIG. 2). In FIG.

6, the characteristics of the low friction road surface motor torque control step 1 (212) and the low friction road surface motor torque control step 2 (218), which are two aspects of the method of controlling the motor torque the vehicle, are illustrated together with the characteristics of a basic control to identify the relative difference.

As illustrated in FIG. 6, the basic control (dashed line graph), without considering the road characteristics, increases the motor torque as the operation amount of the accelerator pedal increases. The basic control then slowly changes the rate of change (tilt) of the motor torque when the motor torque reaches a predetermined value. The motor torque control aspect is a control aspect, which considered the oscillation performance of the vehicle as a top priority.

The low friction road surface motor torque control step 1 (solid line graph) is to control the torque of the motor 150, based on the road surface characteristic determination result, by determining the wheel behavior characteristic of the vehicle at a present time without utilizing the past motor torque control data. As illustrated in FIG. 6, the low friction road surface motor torque control step 1 is to lower a maximum value of the motor torque than in the case of the basic control (dashed line graph). In other words, the controller 102 also increases the motor torque as the operation amount of the accelerator pedal increases, while maintaining the motor torque at a position where the motor torque is relatively smaller than that of the basic control (dashed line graph). The motor torque is then lowered to a smaller value and the motor torque at the lowered state is maintained. This is to allow the vehicle to start stably by lowering the motor torque below the predetermined value at which the wheel spin is not generated. This is because the motor torque is too high on the low friction road surface, causing the wheel spin and the vehicle to start unstable.

The low friction road surface motor torque control step 2 (two dashed line graph) utilizes past motor torque control data, but controls the torque of the motor 150 when the current temperature is lower than 0° C. As illustrated in FIG. 6, in the low friction road surface motor torque control step 2, the rate of change (tilt) and the maximum value of the motor torque are relatively smaller than the basic control (dashed line graph) and the low friction road surface motor torque control step 1 (solid line graph). In other words, the controller 102 increases the motor torque as the operation amount of the accelerator pedal increases, while maintaining the motor torque at a position where the motor torque is relatively much smaller than in the case of the basic control (dashed line graph). However, in the low friction road surface motor torque control step 2, the rate of change of the motor torque is relatively smaller than the basic control (dashed line graph) or the low friction road surface motor torque control step 1 (solid line graph). This is because the temperature is low even on the low friction road surface, so that the rate of change of the motor torque is further lowered so that the vehicle can start more stably.

Returning to FIG. 2, when it is determined that the current road surface is not the low friction road surface (NO in 210), the controller 102 may determine that the current road surface characteristic is at least one of the high friction road surface, the specific road surface, and a slope. Thus, the motor torque may be controlled in the aspect of the basic control (dashed line graph) mentioned in the description of FIG. 6 above.

Based on the road surface characteristic determination result, when the control of the motor torque 212 and 218 considering the low friction road surface is completed, the controller 102 may store (update) a current value related to the motor torque control in the memory 170 (230). The current value related to the motor torque control may include the current position and a current time (including a date), the road surface characteristic determination result, and the motor torque control value.

In addition, the controller 102 may display the road surface characteristic of the current position on the display of an instrument cluster of a vehicle (232). The controller 102 may be displayed through another display (for example, a navigation screen or LED lamp) in addition to the cluster. Through the display of the road surface characteristics, the passenger may recognize the road surface characteristics where the vehicle is currently located.

According to the embodiments of the disclosure, the road surface characteristics are determined based on the wheel behavior characteristics during the starting control of the eco-friendly vehicle equipped with the motor. The vehicle is stably started by controlling the torque of the motor before significant wheel spin occurs when starting the vehicle based on the road characteristic determination result.

The disclosed embodiments are merely illustrative of the technical idea. Those having ordinary skill in the art should appreciate that various modifications, changes, and substitutions may be made without departing from the essential characteristics thereof. Therefore, the embodiments disclosed above, and the accompanying drawings, are not intended to limit the technical idea, but to describe the technical spirit of the disclosure. The scope of the technical idea is not limited by the embodiments and the accompanying drawings. The scope of protection shall be interpreted by the following claims, and all technical ideas within the scope of equivalent shall be interpreted as being included in the scope of rights.

What is claimed is:

1. A method of controlling a motor torque of an eco-friendly vehicle, the method comprising:
determining a wheel behavior characteristic of a vehicle;
determining a road surface characteristic of a road on which the vehicle is located based on the wheel behavior characteristic of the vehicle; and
controlling a motor torque of the vehicle based on the road surface characteristic.

2. The method according to claim 1, wherein the determining of the wheel behavior characteristic comprises:
determining the wheel behavior characteristic of the vehicle using a wheel jerk, a wheel speed, and the motor torque of the vehicle.

3. The method according to claim 2, wherein the determining of the road surface characteristic comprises:
when a wheel jerk Wⱼₑᵣₖ and a motor torque Tₘₒₜₒᵣ the vehicle satisfy each motor of preset reference range, and a wheel acceleration decel W_{decel} and a wheel acceleration code count value Cnt_{wdecel} satisfy each preset reference range, determining the road surface characteristic as a low friction road surface.

4. The method according to claim 3, wherein the determining of the road surface characteristic comprises:
when the wheel jerk Wⱼₑᵣₖ and the motor torque Tₘₒₜₒᵣ of the vehicle do not satisfy each preset reference range, and the wheel acceleration W_{decel} and the wheel acceleration code count value Cnt_{wdecel} do not satisfy each preset reference range, determining the road surface characteristic as a high friction road surface.

5. The method according to claim 4, further comprising:
calculating the wheel acceleration W_{decel} or the wheel jerk Wⱼₑᵣₖ based on a rate of change of a wheel speed of a left driving wheel and a right driving wheel of the vehicle.

6. The method according to claim 5, wherein the wheel acceleration is calculated as in Equation 1 below:
$${W}_{decel} = 0.5 * ⌊ \frac{d}{dt} ( {WSPD}_{LH} ) + \frac{d}{dt} ( {WSPD}_{RH} ) ⌋ \qquad 〈 Equation 1 〉$$
wherein, in Equation 1, W_{decel} is the wheel acceleration, and WSPD_{LH} and WSPD_{RH} are the wheel speeds of the left and right driving wheels.

7. The method according to claim 5, wherein the wheel jerk is calculated as in Equation 2 below:
$${W}_{jerk} = 0.5 * ⌊ \frac{{d}^{2}}{{dt}^{2}} ( {WSPD}_{LH} ) + \frac{{d}^{2}}{{dt}^{2}} ( {WSPD}_{RH} ) ⌋ \qquad 〈 Equation 2 〉$$
wherein, in Equation 2, Wⱼₑᵣₖ is the wheel jerk, and WSPD_{LH} and WSPD_{RH} are the wheel speeds of the left and right driving wheels.

8. The method according to claim 1, wherein the controlling of the motor torque comprises:
controlling the motor torque to reduce a wheel spin of the vehicle when the determined road surface characteristic is a low friction road surface.

9. The method according to claim 1, further comprising:
displaying a result of determining the road surface characteristic on a display.

10. The method according to claim 9, wherein the displaying comprises:
displaying on the display that the current road surface is a low friction road surface when the road surface characteristic determination result is the low friction road surface.

11. An eco-friendly vehicle comprising:
a motor configured to generate power for driving a vehicle; and
a controller configured to
determine a wheel behavior characteristic of the vehicle,
determine a road surface characteristic of a road on which the vehicle is located based on the wheel behavior characteristic of the vehicle, and
control a motor torque of the vehicle based on the road surface characteristic.

12. The eco-friendly vehicle according to claim 11, wherein the controller is configured to determine the wheel behavior characteristic of the vehicle using a wheel jerk Wⱼₑᵣₖ, a wheel speed, and the motor torque Tₘₒₜₒᵣ of the vehicle.

13. The eco-friendly vehicle according to claim 12, wherein, when a wheel jerk Wⱼₑᵣₖ and a motor torque Tₘₒₜₒᵣ of the vehicle satisfy each preset reference range, and a wheel acceleration W_{decel} and a wheel acceleration code count value Cnt_{wdecel} satisfy each preset reference range, the controller is configured to determine the road surface characteristic as a low friction road surface.

14. The eco-friendly vehicle according to claim 13, wherein, when the wheel jerk Wⱼₑᵣₖ and the motor torque Tₘₒₜₒᵣ of the vehicle do not satisfy each preset reference range, and the wheel acceleration W_{decel} and the wheel acceleration code count value Cnt_{wdecel} do not satisfy each preset reference range, the controller is configured to determine the road surface characteristic as a high friction road surface.

15. The eco-friendly vehicle according to claim 14, wherein the controller is configured to calculate the wheel acceleration W_{decel} or the wheel jerk Wⱼₑᵣₖ based on the rate of change of a wheel speed of a left driving wheel and a right driving wheel of the vehicle.

16. The eco-friendly vehicle according to claim 15, wherein the controller is configured to calculate the wheel acceleration as in Equation 1 below:
$${W}_{decel} = 0.5 * ⌊ \frac{d}{dt} ( {WSPD}_{LH} ) + \frac{d}{dt} ( {WSPD}_{RH} ) ⌋ \qquad 〈 Equation 1 〉$$
wherein, in Equation 1, W_{decel} is the wheel acceleration, and WSPD_{LH} and WSPD_{RH} are the wheel speeds of the left and right driving wheels.

17. The eco-friendly vehicle according to claim 15, wherein the controller is configured to calculate the wheel jerk as in Equation 2 below:
$${W}_{jerk} = 0.5 * ⌊ \frac{{d}^{2}}{{dt}^{2}} ( {WSPD}_{LH} ) + \frac{{d}^{2}}{{dt}^{2}} ( {WSPD}_{RH} ) ⌋ \qquad 〈 Equation 2 〉$$
wherein, in Equation 2, Wⱼₑᵣₖ is the wheel jerk, and WSPD_{LH} and WSPD_{RH} are the wheel speeds of the left and right driving wheels.

18. The eco-friendly vehicle according to claim 11, wherein the controller is configured to control the motor torque to reduce a wheel spin of the vehicle when the determined road surface characteristic is a low friction road surface.

19. The eco-friendly vehicle according to claim 11, wherein the controller is configured to display a result of determining the road surface characteristic on a display.

20. The eco-friendly vehicle according to claim 19, wherein the controller is configured to display on the display that the current road surface is a low friction road surface when the road surface characteristic determination result is the low friction road surface.
